(19) United States
(12) Patent Application Publication
(10) Pub. No.: US 2004/0098544 A1
(43) Pub. Date: May 20, 2004

(54) Method and apparatus for managing a memory system

(76) Inventors: Blaine D. Gaither, Fort Collins, CO (US); Benjamin D. Osecky, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/294,718

(22) Filed: Nov. 15, 2002

(51) Int. Cl. G06F 12/00

(52) U.S. Cl. 711/154

(57) ABSTRACT

In a method of managing memory, a plurality of check values are generated from contents of memory. Each check value is associated with a respective page in a memory system in a data structure. The data structure is searched for a candidate page having identical content to a requesting page in the memory system by utilizing a check value of the requested page in the search.

### BACKGROUND

A single-user data processing system typically consists of a processor, a volatile memory, e.g., random access memory (RAM) for storing instructions and data, and some form of permanent storage, e.g., a magnetic disk.

A multi-processing (MP) data processing system is often used by multiple users. For example, virtual machines executing on the MP data processing system present to each user the appearance of having sole control of all the resources of the system. As a result, a respective partition in the volatile memory and the persistent storage memory is maintained for each virtual machine executing on the MP data processing system. However, each of the partitions may contain some data that is identical to data existing in other partitions, e.g., operating system kernels. As a result, memory usage is typically not optimized among the partitions, thereby, increasing the overall cost of the MP data processing systems.

Similarly, in a blade server environment or a set of servers sharing an external mass storage array, the mass storage disk array may be divided among the blade servers or servers. A blade server may be implemented as a single circuit board populated with components such as processors, memory, and network connections that are usually found on multiple boards in a conventional server. Blade servers are designed to slide into existing blade server enclosures. Each blade server may be assigned and execute a partition. A plurality of the partitions may execute the same operating system and applications for different users. Accordingly, many of the mass storage partitions may contain duplicate information.

### SUMMARY

An embodiment relates a method for managing a memory system. The method includes generating a plurality of check values from contents of memory and associating each check value of the plurality of check values to a respective page in the memory system in a data structure. The method also includes searching the data structure for a candidate page having identical content to a requesting page in the memory system, where a check value of the requested page is used to search the data structure.

Another embodiment pertains to an apparatus for managing access to memory subsystems. The apparatus includes a memory adapted to provide storage for a plurality of processors and a virtual compression system (VCS) configured to divide the memory system into a plurality of partitions. Each partition is assigned to a respective subset of processors of the plurality of processors, where the VCS is also configured to receive a virtual address from a selected processor of the subset of processors. The VCS is further configured to identify a partition and to translate the virtual address to a real address within a respective partition of the selected processor.

Yet another embodiment relates to a method for managing a memory. The method includes comparing a check value computed from a content of a selected page with respective check values of a plurality of pages of the memory and selecting a matching page in response to the check value and respective check value of the matching page being equal. The method also includes comparing the selected page and the matching page and redirecting a virtual address of one of the selected page and the matching page to a physical address of other one of the selected page and the matching page in response to the selected page and the matching page being identical in content.

Yet another embodiment pertains to a method for managing a memory. The method includes writing data to a selected page of the memory and determining a status of the selected page. The method also includes requesting a page from a free page pool of the memory in response to the selected page being shared and writing contents of the selected page onto the requested page. The method further includes generating a hash value based on respective content of the requested page and searching for other pages based on the hash value.

Yet another embodiment relates to an apparatus for managing memory. The apparatus includes means for writing data to a selected page of the memory and means for determining a status of the selected page. The apparatus also includes means for requesting a page from a free page pool of the memory in response to the selected page being shared and means for writing contents of the selected page onto the requested page. The apparatus further includes means for generating a hash value based on respective content of the requested page and means for searching for other pages based on the hash value.

### BRIEF DESCRIPTION OF THE DRAWINGS

FIG. 1 illustrates an exemplary block diagram of a system where an embodiment may be practiced;

FIG. 2 illustrates a detailed block diagram of an embodiment

FIG. 3 illustrates a page partition page table according to another embodiment;

FIG. 4 illustrates a check value table utilized according to an embodiment;

FIG. 5 illustrates an exemplary flow diagram of a read method according to an embodiment;

FIG. 6 is a key to FIGS. 6A-B;

FIGS. 6A-B, collectively, illustrate an exemplary flow diagram of a write mode according to an embodiment;

FIG. 7 is a key to FIGS. 7A-B;

FIGS. 7A-B, collectively, illustrate an exemplary flow diagram of an optimization mode according to an embodiment; and

FIGS. 8A-C illustrate various embodiments.

### DETAILED DESCRIPTION OF EMBODIMENTS

An embodiment pertains to a virtual compression system (VCS) configured to optimize memory systems. More particularly, the memory system may be divided into partitions, where each partition may be assigned to a device, process, processor, a set of processors, a virtual machine, etc. The VCS may determine common pages of memory among the partitions. The VCS may reconfigure the virtual address mapping of the pages of identical content in the memory to point to (or share) a physical common page, i.e., virtual compression. The duplicate pages of memory are de-referenced, i.e., removing any mapping to the duplicate pages and returning the duplicate pages to a free page pool, which is maintained by the VCS. Accordingly, the use of memory space within partitions is optimized.

In another embodiment, the VCS may be configured to maintain a partition page table for a selected partition. The partition page table is configured to maintain an association for virtual addresses and the corresponding physical addresses of pages of memory assigned for the selected partition. For each association, the partition page table is also configured to maintain a copy counter (or flag, semaphore, etc.) to indicate whether the physical address of a selected entry may be shared by other partitions/devices/processes.

Accordingly, in another embodiment, the partition page table may be utilized during a write for a selected partition. More particularly, for a write operation to a page of memory, the VCS may access the partition page table to determine whether the write operation affects an existing page of memory. If the search of the partition page table determines that no existing page of memory is affected, the VCS may request a free page from a free page pool maintained by the VCS. The free page is removed from the data structure that represents the free pool (or list). The requested data is then written onto the free page. The VCS may also update the partition page table and a check value table with values corresponding to the new page.

If the search of the partition page table determines that only one virtual page is mapped to the corresponding real page, the requested data is written to the corresponding address within the corresponding real page. The VCS may also update the partition page table and check value corresponding to the newly written page.

Otherwise, if the VCS determines that more than one page of memory is affected by the write operation and the at least one page of memory is shared, the VCS may retrieve a free page of memory from a free page pool and update the data structure that represents the free page pool to remove this free page from the free page pool. The VCS may copy the data from the shared page of memory onto the free page and then modify the contents of the page with the write operation. The VCS may then update the partition page table and the check value table with the newly modified page. In the event that a free page of memory is not available from the free page pool, the VCS may be configured to generate an indication for the operating system, user and/or system administrator to take appropriate action.

In yet another embodiment, the VCS may maintain a check value table. The check value table may be configured to maintain a searchable association between a physical page of memory and a respective check value. The check value may be a checksum or hash value generated from the physical page of memory. Accordingly, in yet another embodiment of the invention, duplicate page of memories may be determined and optimized by utilizing the check value table in response to an event such as a write operation, a periodic initiation, etc. In other embodiments, the check value may be obtained from external sources such as the CRC values associated network transmission, CRC values generated by a disk controller, etc.

More particularly, a check value of a selected page of memory may be used to search the check value table. If a matching check value is found within the check value table, a byte-by-byte comparison may then be performed between the selected page of memory and the matching page of memory. If there is not a match between the selected page and matching page of memory, the VCS may return to finish searching the rest of the check value table in the partition page table of the selected page. Otherwise, if there is match between the selected page of memory and the matching page of memory, the VCS may de-reference the selected page of memory and return the de-referenced page to the free page pool. The VCS may also update change the association between the virtual address of the selected page to the real address of the matching page of memory. The VCS may also update the respective partition page table that references the matching page by incrementing a copy counter field to indicate another partition/process/device is sharing the matching page of memory. Thus, memory systems may be optimized across partitions.

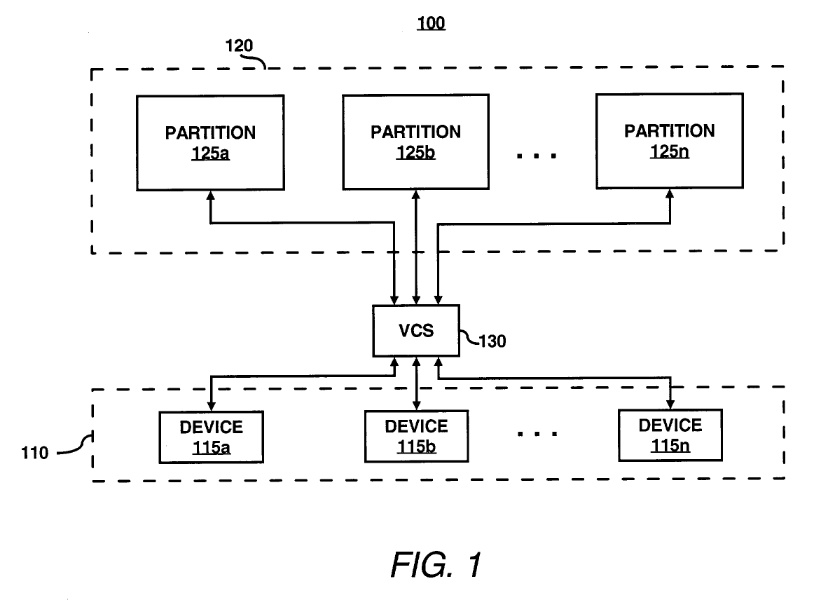

FIG. 1 illustrates an exemplary block diagram of a system 100 where an embodiment may be practiced. It should be readily apparent to those of ordinary skill in the art that the system 100 depicted in FIG. 1 represents a generalized schematic illustration and that other components may be added or existing components may be removed or modified.

As shown in FIG. 1, the system 100 includes a processing complex 110, a memory system 120, and a virtual compression system (labeled as ‘VCS’) 130. The processing complex 110 may include a number of devices 115a . . . 115n. Each device, e.g., 115a, may be implemented with a microprocessor, a controller, a disk drive controller or other similar processing device capable of managing multiple partitions. Alternatively, the processing complex 110 may be a single device such as microprocessor, a controller, a disk drive controller or other similar processing device capable of managing multiple partitions.

The processing complex 110 may be configured to manage multiple partitions within the memory system 120. The memory system 120 may be implemented as a cache, a main memory of a computer system, a virtual memory system, a storage disk, disk array, or other similar storage device capable of being divided into partitions or shared as partitions e.g., partitions 125a . . . 125n. The processing complex 110 may also be configured to access the memory system 120 according to conventional addressing schemes for the respective type of memory.

The processing complex 110 may be configured to access memory system 120 in units of finite size, e.g., page, block, line, or other similar unit. Moreover, the unit of access may be configured to comprise data, partition designation, and an address within the selected partition. The partition designation might be presented by the processing complex 110 as part of the virtual address or it might be kept in a VCS 130 as part of the processes that manage the partitions. From the partition designation, e.g., a number, and the address presented by the processing complex 110, the VCS 130 may generate a physical address that is presented to the memory system 120.

The VCS 130 may be interfaced with the processing complex 110 and the memory system 120. In one embodiment, the VCS 130 may be situated on an address bus (not shown) between the processing complex 110 and the memory system 120. In another embodiment, the VCS 130 may be integrated with the processing complex 110. In yet another embodiment, the VCS 130 may be integrated within the memory system 120. Moreover, it should be readily apparent to those skilled in the art that various embodiments may be implemented in hardware, software or a combination thereof.

The VCS 130 may be configured to optimize a memory system 120 by identifying units of memory, where the units of memory may be a page, a block, a line, etc., that share identical content among a plurality of partitions. The VCS 130 may then reconfigure the virtual addresses of the common units of memory to point to a single common unit, i.e., virtual compression. More specifically, in one embodiment, the VCS 130 may virtually compress the memory system 120 in response to an event (e.g., a write) or to a periodic invocation. The VCS 130 may select a candidate unit of memory, e.g., a page, and compare an associate check value (e.g., a checksum, a hash value, etc.) with the check values of the respective pages of memory. If the checksums match, the VCS 130 may perform a byte-by-byte comparison between the candidate page and the matching page. If the pages are determined to be identical, a page partition table (not shown) for the partition of the candidate page is updated. The page partition table may be configured to associate a virtual address of a page, i.e., the address received from the device/process, with a real address of the page, i.e., the address in the memory system 120. Accordingly, the entry for the candidate page in the page partition table is updated with real address of the matching page.

In one embodiment, a copy counter may be associated with each entry in the page partition table. Accordingly, when a new identical page has been determined, the copy counter may be incremented for each entry that references the matching page across the partitions.

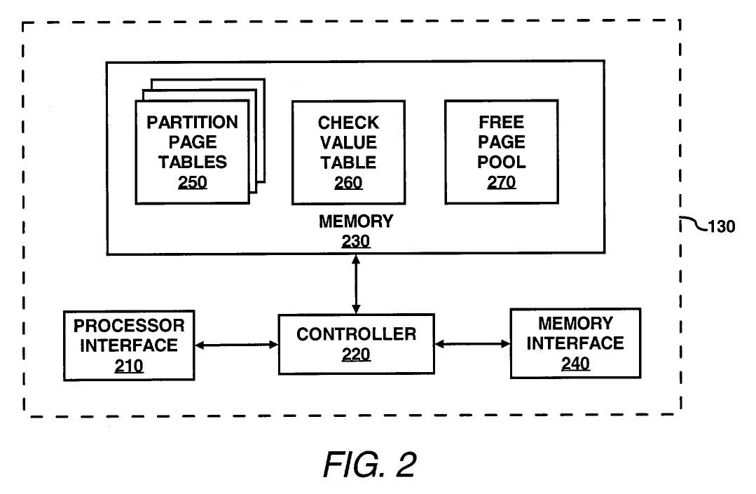

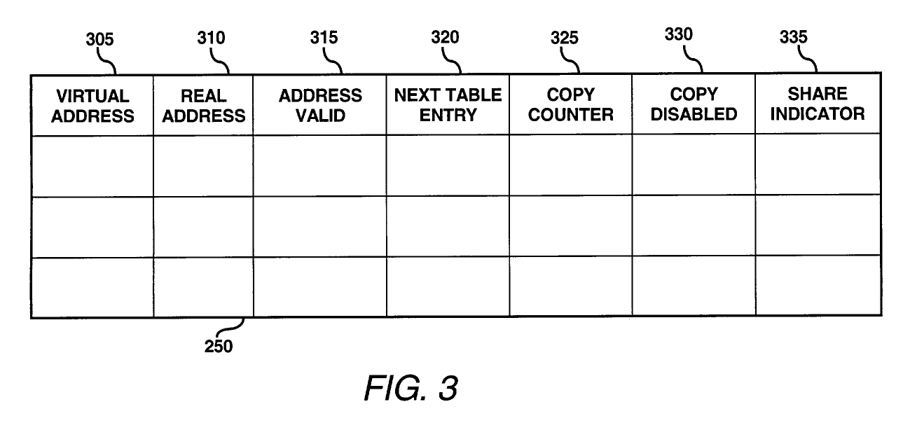

FIG. 2 illustrates an exemplary block diagram of an embodiment 200 of the VCS 130 shown in FIG. 1. It should be readily apparent to those of ordinary skill in the art that the VCS 130 depicted in FIG. 3 represents a generalized schematic illustration and that other components may be added or existing components may be removed or modified.

As shown in FIG. 2, the VCS 130 may include a processor interface 210, a controller 220, a memory 230, and a memory interface 240. The processor interface 210 may be adapted to communicate commands, data, and/or addresses between a device (or processor, process, etc.) and the VCS 130. The processor interface 210 may be configured to connect to a bus or other similar information channel between a device and a memory system.

The controller 220 may be configured to provide an execution engine for the VCS 130. The controller 220 may be implemented as a microprocessor, controller, a state machine or other similar device or application specific integrated circuit (ASIC). Alternatively, the functions of the VCS 130 may be integrated with a processing device or a memory system.

The controller 220 may also be configured to interface with a memory 230. The memory 230 may be configured to be a storage device for a computer program embodiment of the VCS 130. The memory 230 may also be used to provide storage of data structures, e.g., a table, a linked list, etc. Alternatively, in another embodiment, the data structure may be stored and maintained in the memory system 120.

In another embodiment, the memory 230 may be configured to store partition page tables 250, a check value table 260 and a free page pool 270. The partition page tables 250 may provide an address translation mechanism for the VCS 130. More particularly, the partition page table 250 may map (or link) a virtual address with a corresponding real address for a particular partition. A partition page table 250 would be created and managed for each partition created on the memory system 120. Accordingly, the VCS 130 may receive a virtual address from a device through the processor interface 210, where the address comprises data, a partition indicator and a virtual address. The VCS 130 may use the partition indicator to select the appropriate partition page table and then use the virtual address to determine the corresponding real address. The VCS 130 may then forward the real address to the memory system 120 through the memory interface 240.

FIG. 3 illustrates a partition page table 250 shown in FIG. 2 in accordance with an embodiment. It should be readily apparent to those of ordinary skill in the art that the partition page table 250 depicted in FIG. 3 represents a generalized schematic illustration and that other fields may be added or existing fields may be removed or modified.

As shown, the partition page table 250 comprises a virtual address field 305, a real address field 310, an address valid field 315, a next table entry field 320, a copy counter field 325, a copy disabled field 330, and a share indicator field 335.

The virtual address field 305 may store the virtual addresses of pages of memory that are used by the partitions. The partition page table 250 may be indexed by the values in the virtual address field 305. As an example, the page partition table 250 may be implemented with an associative memory, thereby allowing quick identification of any matching values.

The real address field 310 may store a corresponding real address in the memory system 120. A value in the address valid field 315 may provide an indication whether the real address is valid for the virtual address. A value in the next table entry field 320 may provide an indication whether there are any other virtual addresses sharing the corresponding real address. A value in the copy counter field 325 may provide an indication of the virtual addresses that share the real address. A value in the copy disabled field 330 may provide an indication of whether the real address is to be shared. There may be a need for the copy disabled field 330 when the share indicator field 335 is provided in the page table (or elsewhere) that identifies all the virtual addresses (in the page table entries) sharing the page.

Returning to FIG. 2, the check value table 260 may provide a mechanism for the VCS 130 to quickly identify units of memory, e.g., a page. More particularly, a check value, e.g., a check sum, a hash value, etc., of a selected page of memory may be used to search the check value table. For example, the check value table 260 may be configured that a checksum of a selected page may index into the check value table 260. Alternatively, the check value table 260 may be indexed by a hash computed from the check value. If a matching checksum is found in the check value table 260, the VCS 130 may compare the selected page with the matching page. If the pages are identical, the VCS 130 update the partition page table of the selected page with the corresponding real address of the matching page. The VCS 130 may also de-allocate or de-reference the selected physical page and return the de-referenced physical page to the free page pool 270, which is configured to maintain a list of available pages of memory for the memory system 120.

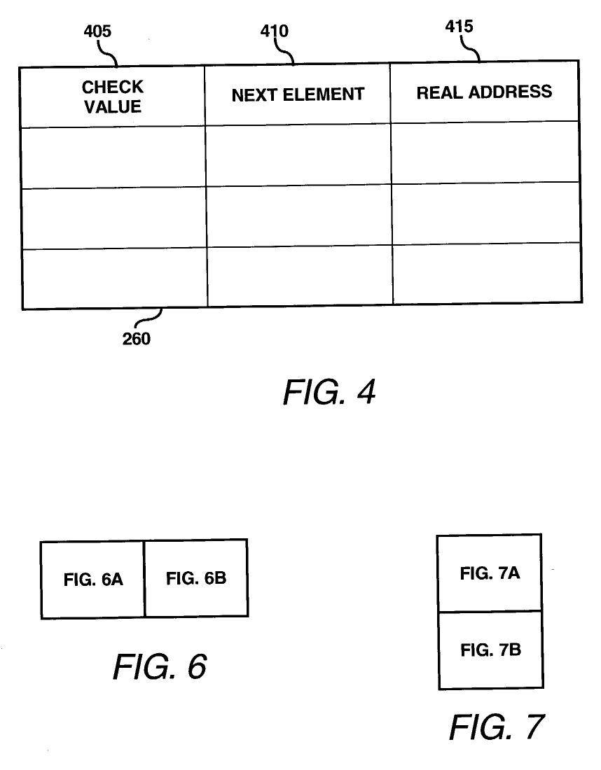

FIG. 4 illustrates an exemplary check value table 260 in accordance with an embodiment. It should be readily apparent to those of ordinary skill in the art that the check value table 260 depicted in FIG. 4 represents a generalized schematic illustration and that other fields may be added or existing fields may be removed or modified.

As shown in FIG. 4, the check value table 260 may comprise a check value field 405, a next element field 410, and a real address field 415. The check value field 405 may store the check value for each corresponding active page of memory in the memory. The check value may be generated using checksum algorithms, hashing algorithms, or other similar techniques. In other embodiments, the VCS 130 may use check values from external sources. By way of example, the VCS 130 may use the CRC values associated with the transmission of a packet of data received by a system executing the VCS 130. As another example, the VCS 130 may use the CRC values generated by a disk controller writing data to a mass storage device.

The next element field 410 may provide an indication of another entry in the check value table 260 that share the same check value. In some instances, two different pages of memory may generate an identical hash value. Accordingly, in order to reduce search time, the check value table 260 provides an indication of the other entries with the same hash value. The real address field 415 may provide the corresponding real address associated with the check value.

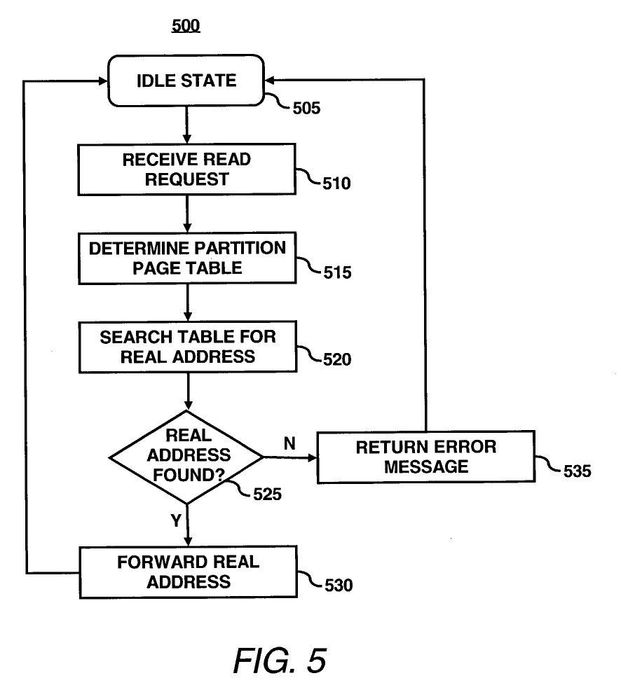

FIG. 5 illustrates an exemplary flow diagram of a read mode 500 for the controller 220 of the VCS 130 shown in FIG. 2 in accordance with yet another embodiment. It should be readily apparent to those of ordinary skill in the art that the read mode 500 represents a generalized illustration and that other steps may be added or existing steps may be removed or modified.

As shown in FIG. 5, the controller 220 of the VCS 130 may be configured to be in an idle state, in step 505. The controller 220 may receive a read request from the processor interface 210 in step 510. The read request may comprise of data, partition designation, and an address within that partition, i.e., the virtual address.

In step 515, the controller 220 may use the partition designation to select the appropriate partition page table. The controller 220 may then use the virtual address to search the selected partition page table to determine a real address, in step 520.

If a real address is found, in step 525, the controller 220 may forward the real address to the memory system 120 through the memory interface 220, in step 530. Subsequently, the controller 220 may return to the idle state of step 505. Otherwise, the controller 220 may return an error message to the requesting processor through the processor interface 210, in step 535 and subsequently return to the idle state of step 505.

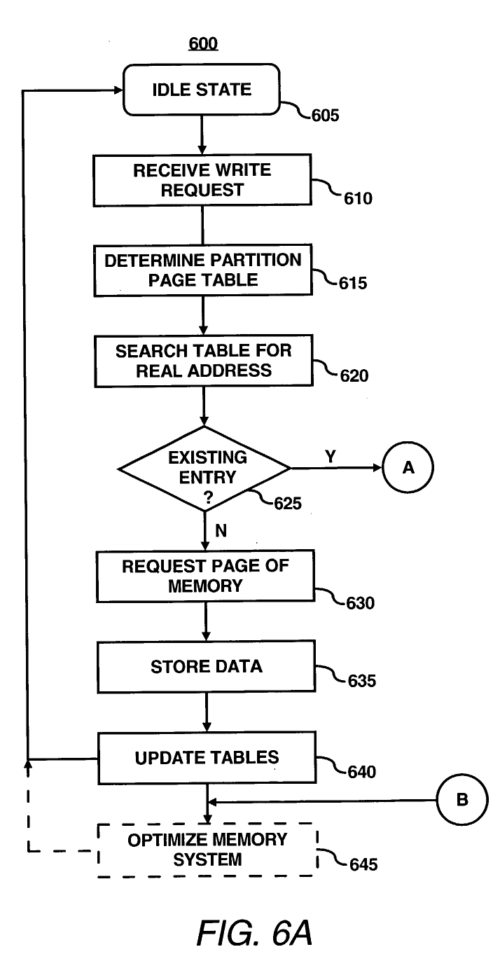

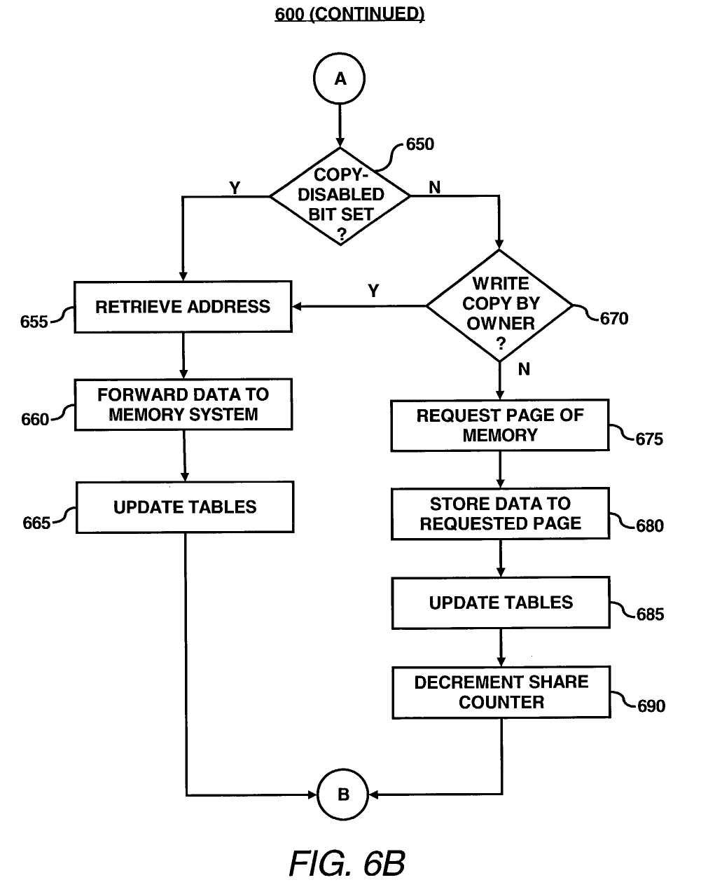

FIGS. 6A-B, collectively, illustrate an exemplary flow diagram of a write mode 600 for the controller 220 of the VCS 130 shown in FIG. 2 in accordance with another embodiment. It should be readily apparent to those of ordinary skill in the art that the write mode 600 represents a generalized illustration and that other steps may be added or existing steps may be removed or modified.

As shown in FIG. 6, the controller 220 of the VCS 120 may be configured to be in an idle state, in step 605. In step 610, the controller 220 may receive (or intercept) a write request from the device 110 to the memory system 120 through the processor interface 210.

From the receive write request, the controller 220 may determine the partition page table, in step 615. The virtual address associated with the write request is then used as an index into the selected partition page table (e.g., partition page table 260 shown in FIG. 3), in step 620.

In step 625, the controller 220 may determine whether a real address exists for the requested virtual address. If the controller 220 determines that the associated real address is non-existent, the controller 220 may request a page of memory from the free page pool 270, in step 630.

In step 635, the controller 220 may forward the received data to the requested page for storage by the memory system 120. The memory system 120 may return the real or physical address of the requested page.

In step 640, the controller 220 may update the page partition table of the selected partition with the real address of the requested page. The controller 220 may also generate a check value (e.g., a checksum or hash value) on the requested page and update the check value table with the virtual address along with the real address of the requested page and the associated check value. Subsequently, the controller 220 may return to the idle state of step 605.

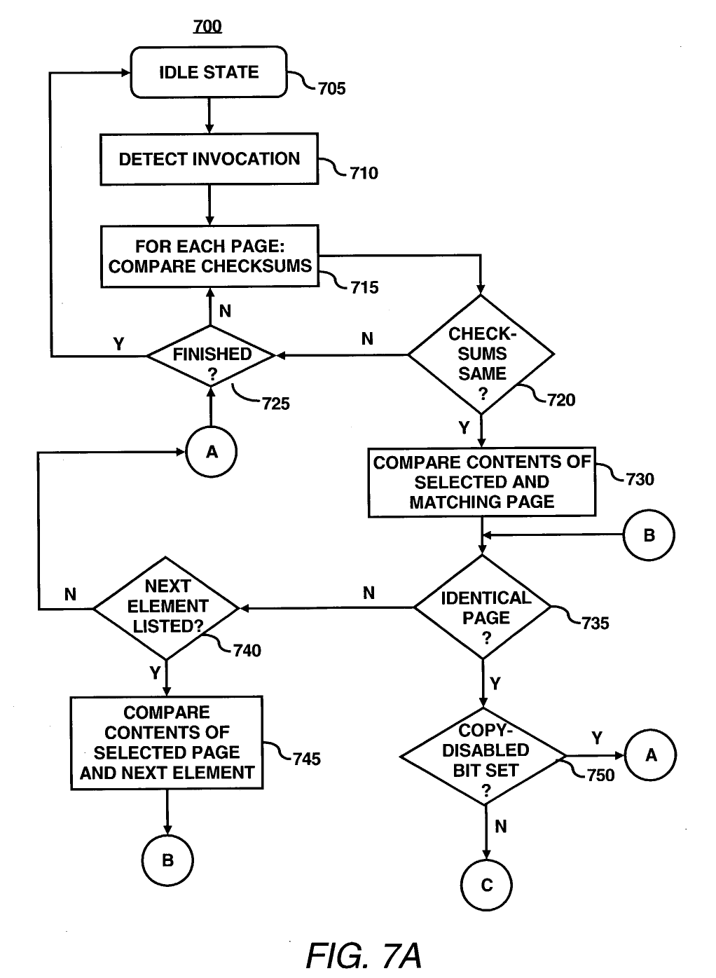

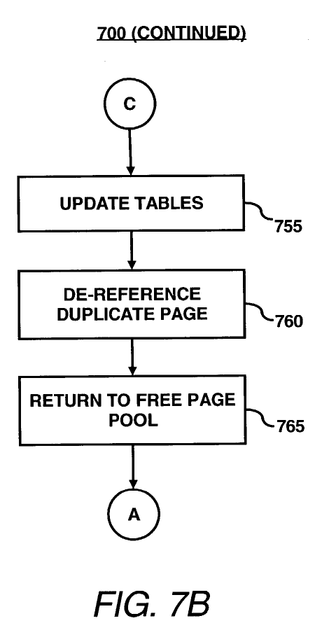

Optionally, in step 645, the controller 220 may initiate an optimization mode for the controller 220 in order to virtually compress the memory system 120. Further detail of the optimization mode for the controller is described below with respect to FIGS. 7A-B. Subsequently, the controller 220 may return to the idle state of step 605.

Referring to FIG. 6B, if the controller 220 determines that a real address exists for the requested virtual address, the controller 220 may test if the copy disabled field 330 has been set for the requested page, in step 650. If the copy disabled bit has been set, the controller 220 may retrieve the real address of the requested page by searching the page partition table with the requested virtual address, in step 655.

In step 660, the requested data is forwarded to the memory system 120 along with the real address for the memory system 120. In step 665, the controller 220 may generate a check value (e.g., a checksum or hash value) on the requested data and update the check value table with the virtual address of the write request along with the real address of the requested page and the associated check value. Alternatively, the controller 220 may use check values generated from external devices and/or processes. Subsequently, the controller 220 may proceed with the optimization of memory as described with respect to step 645 (shown in FIG. 6A).

Returning to step 650, if the controller 220 determines that the copy disabled field 330 has not been set, the controller 220 may determine whether the write request is initiated by the owner of the page, i.e., a single copy of the page, in step 670. In an embodiment, the controller 220 may access the share indicator field 335 of the partition page table 250 (shown in FIG. 2 and 3). If the controller 220 determines that the owner of the page initiates the write request, the controller 220 may proceed to the processing of step 655.

Otherwise, if the controller 220 determines that the requested page is shared, the controller 220 may request a page of memory from the free page pool 270, in step 675. In step 680, the controller 220 may copy the contents of the matching page to the requested page and forward the requested data to the memory system 120 to perform the write operation.

In step 685, the controller 220 may update the page partition table of the selected partition with the real address of the requested page. The controller 220 may also generate a check value (e.g., a checksum or hash value) on the requested data and update the check value table with the virtual address of the write request along with the real address of the requested page and the associated check value. In step 690, the controller 220 may decrement copy counter field 325 in the page partition tables of the pages that reference the matching page. Subsequently, the controller 220 may proceed to the processing to the memory optimization of step 645 (shown in FIG. 6A).

FIGS. 7A-B collectively illustrate an exemplary flow diagram of an optimization mode 700 for the controller 220 of the VCS 130 shown in FIG. 2. It should be readily apparent to those of ordinary skill in the art that the optimization mode 700 represents a generalized illustration and that other steps may be added or existing steps may be removed or modified.

As shown in FIG. 7A, the controller 220 may be configured to be in an idle state in step 705. The controller 220 may detect an invocation of the optimization mode 700, in step 710. The optimization mode 500 may be invoked periodically or by an event such as a conclusion of a write request.

In step 715, the controller 220 may be configured to select a page to determine if there is an identical page in the memory system 120. More specifically, the controller 220 may process all or a subset of modified unprocessed pages. The controller 220 may use the check value of the selected page to search the check value table 260. If there is not a match between the check value of the selected page and a check value in the table, the controller 220 may determine whether the optimization mode 700 has completed, in step 725. If the last page has not been selected, the controller 220 returns to the processing of step 715. Otherwise, the controller may return to the idle state of step 705. Alternatively the optimization may be suspended when a new memory operation is received.

In one embodiment, the controller 220 may select a page on the basis of that page having a write operation performed. In another embodiment of the invention, the controller 220 may sequentially select a page by its position in the check value table 260. Other techniques for selecting page that optimize the selection process are within the scope of the present invention.

Returning to step 720, if there is a match between the check value of the selected page and a check value in the table, the controller 220 may compare the contents of the selected page and the matching page, in step 730. The controller 220, in step 735, may make a determination if the selected page and the matching page are identical based on the comparison in step 730.

If the selected and matching pages are not identical, the controller 740 may determine where the next element field 410 of the matching page in the check value table 260 contains an entry, in step 740. More particularly, there are instances where two pages with different memory content may have the same check value (e.g., a hash value). The check value table 260 may link the two different pages in order to reduce the search time.

If the next element field 410 of the matching page does not contain an entry, the controller 220 may proceed to the processing of step 725, as described above. Otherwise, the controller 220, in step 745, may compare the contents of the selected page and the page pointed by the value in the next element field 410. Subsequently, the controller 220 returns to the processing of step 735.

If, in step 735, the controller 220 determines that the selected and matching page are identical, the controller 220 may determine whether the copy disabled bit has been set for the matching page, in step 750. If the copy-disabled bit has been set, the controller 220 may return to the processing of step 725.

Otherwise, with reference to FIG. 7B, the controller 220 may update the appropriate tables, in step 755. More particularly, the controller 220 may update the real address field 415 of the selected page with the real address of the matching page in the check value table 260. The controller 220 may also update the page partition table of the selected page with the real address of the matching page and mark the address valid field 315 as the address being valid. The controller 220 may further update the page partition table of the matching page by incrementing the copy counter field 325.

In step 760, the controller 220 may de-reference or de-allocate the selected page and return the de-reference page to the free page pool 270, in step 765.

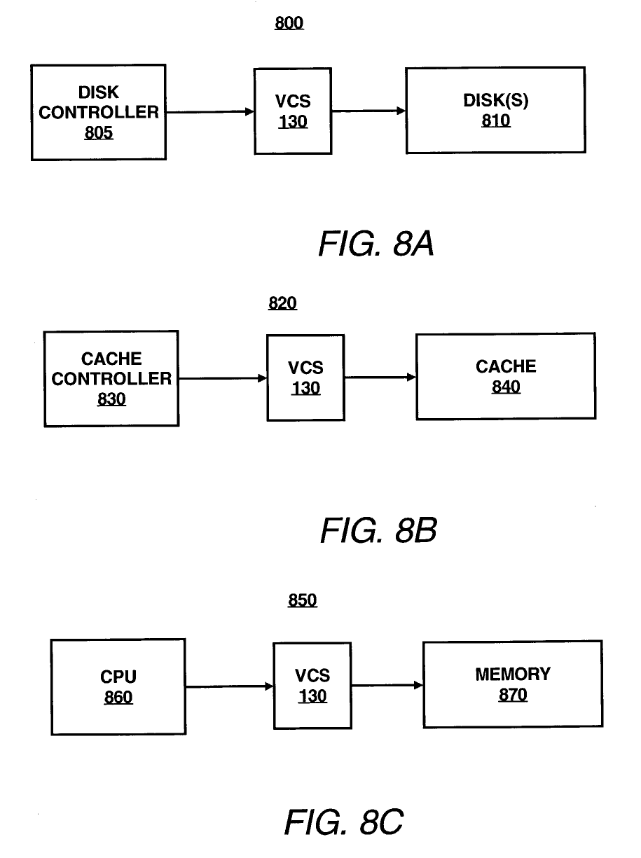

FIGS. 8A-C respectively illustrate exemplary systems where various embodiments may be practiced. As shown in FIG. 8A, the VCS 130 may be integrated into a disk storage system (or platform) 800. The mass storage system 800 includes a disk controller 805 and at least one disk 810. The disk controller 805 may be configured to map multiple partitions, each partition for the storage of software applications and/or data for a respective user/device. The VCS 130 may optimize the storage of the software applications and/or data by sharing a single instance of common data among the partitions, i.e., a virtual compression of the disk storage system 800.

FIG. 8B illustrates a block diagram of a cache system 820 where an embodiment may be practiced. The cache system 820 may include a cache controller 830 and a cache memory 840. The cache controller 830 may be configured to provide cache services to multiple partitions, where each partition may store instructions and/or data. Sharing of a single instance of common instructions and/or data among the multiple partitions by utilizing an embodiment of the VCS 130 may optimize the storage space in the cache memory 840.

FIG. 8C illustrates a block diagram of a computer system 850 where an embodiment may be practiced. The computer system 850 may include a central processing unit (CPU) 860 and a memory 870. The CPU 860 may be configured to execute multiple partitions, where each partition may store instructions and/or data. Sharing of a single instance of common instructions and/or data among the multiple partitions by utilizing an embodiment of the VCS 130 may optimize the storage space in the memory 870. The computer system 850 may be implemented in a personal computer, a workstation platform, a server platform or other similar computing platform.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method for managing a memory system, comprising:
generating a plurality of check values from contents of memory;
associating each check value of said plurality of check values to a respective page in said memory system in a data structure; and
searching said data structure for a candidate page having identical content to a requesting page in said memory system, wherein a check value of said requested page is used to search said data structure.

2. The method according to claim 1, further comprising:
comparing said requested page with said candidate page in a byte-by-byte manner in response to said check value of said requested page matching associated check value of said candidate page.

3. The method according to claim 2, further comprising:
linking said requested page and said candidate page in response to said content of said requested page and said content of said candidate page being identical.

4. The method according to claim 3, further comprising:
storing an indicator configured to identify said mapping of said requested page and said candidate page.

5. The method according to claim 1, wherein said check value is a checksum value or a hash value.

6. The method according to claim 1, wherein said check value is retrieved from an external source.

7. The method according to claim 1, wherein said searching of said data structure for said candidate page utilizes a subset of one of said checksum value or said hash value.

8. The method according to claim 1, wherein searching said data structure for said candidate page in said memory system is invoked in response to a storage of said requested page in said memory system.

9. The method according to claim 1, wherein searching said data structure for said candidate page in said memory system is invoked periodically.

10. The method according to claim 1, wherein searching said data structure for said identical page in a partition of said memory system.

11. The method according to claim 1, further comprising:
adding said requested page and said check value of said requested page to said data structure; and
forming an association between said requested page and said check value of said requested page.

12. An apparatus for managing access to memory subsystems, comprising:
a memory adapted to provide storage for a plurality of processors; and
a virtual compression system (VCS) configured to divide said memory system into a plurality of partitions, each partition being assigned to a respective subset of processors of said plurality of processors, wherein said VCS is also configured to receive a virtual address from a selected processor of said subset of processors, to identify a partition, and to translate said virtual address to a real address within a respective partition of said selected processor.

13. The apparatus according to claim 12, further comprising:
a free page pool configured to provide a list of available pages of said memory, where said available pages are not accessible by said plurality of partitions.

14. The apparatus according to claim 12, further comprising:
a global table configured to associate pages of said memory system with respective pages of said plurality of partitions.

15. The apparatus according to claim 12, further comprising:
a frame page table configured to each page of said plurality of pages in said memory system with a respective entry is in said frame page table.

16. The apparatus according to claim 15, wherein each entry in said frame page table comprises a reference counter configured to indicate that said respective entry is shared among a sub-plurality of partitions of said plurality of partitions.

17. The apparatus according to claim 12, further comprising:
a hash table configured to store a respective hash value computed from the content of each page for each page of said plurality of pages of said memory system.

18. The apparatus according to claim 12, wherein said VCS is adapted to be integrated with a personal computer platform, a workstation platform, a server platform, a microprocessor chip support set, a storage platform, a cache controller, and a disk controller.

19. A method for managing a memory, comprising:
comparing a check value computed from a content of a selected page with respective check values of a plurality of pages of said memory;
selecting a matching page in response to said check value and a respective check value of said matching page being equal;
comparing said selected page and said matching page; and
redirecting a virtual address of one of said selected page and said matching page to a physical address of other one of said selected page and said matching page in response to said selected page and said matching page being identical in content.

20. The method according to claim 19, further comprising:
de-referencing one of said selected page and said matching page; and
placing said de-referenced page on a free page pool.

21. The method according to claim 20, wherein said selected page and said matching page are associated with a single partition of plurality of partitions.

22. The method according to claim 20, wherein said selected page and said matching page are associated with said memory.

23. A method of managing a memory, comprising:
writing data to a selected page of said memory;
determining a status of said selected page;
requesting a page from a free page pool of said memory in response to said selected page being shared;
writing contents of said selected page onto said requested page;
generating a hash value based on respective content of said requested page; and
searching for other pages based on said hash value.

24. An apparatus for managing memory, said apparatus comprising:
means for writing data to a selected page of said memory;
means for determining a status of said selected page;
means for requesting a page from a free page pool of said memory in response to said selected page being shared;
means for writing contents of said selected page onto said requested page;
means for generating a hash value based on respective content of said requested page; and
means for searching for other pages based on said hash value.
